(19) United States
(12) Patent Application Publication
(10) Pub. No.: US 2023/0382495 A1
(43) Pub. Date: Nov. 30, 2023

(54) MOBILE FLOATING OFFSHORE WIND ENERGY SYSTEM

(71) Applicant: University of Massachusetts, Boston, MA (US)

(72) Inventors: Matthew Lackner, Amherst, MA (US); James Manwell, Conway, MA (US); Aaron Annan, Harwick, MA (US)

(21) Appl. No.: 18/326,502

(22) Filed: May 31, 2023

Related U.S. Application Data
(60) Provisional application No. 63/347,349, filed on May 31, 2022.

(51) Int. Cl. B63B 1/12; F03D 13/25; F03D 9/32; B63B 25/12; B63H 21/17; B63H 25/06; B63H 21/21; B63B 39/03; H02K 7/18; H02K 11/00

(52) U.S. Cl. CPC B63B 1/125; F03D 13/25; F03D 9/32; B63B 25/12; B63H 21/17; B63H 25/06; B63H 21/21; B63B 39/03; H02K 7/1838; H02K 11/0094; F05B 2220/706; F05B 2220/61; F05B 2240/932; F05B 2240/95; B63B 2035/446

(57) ABSTRACT

A wind turbine system comprises a vessel; a wind turbine mounted to the vessel, the wind turbine comprising rotor blades configured to convert an airstream to rotational shaft power, and an electrical generator configured to convert the rotational shaft power to electrical power; a hydrogen production system configured to be powered by the electrical generator; a propulsion system configured to propel the vessel via power from the electrical generator; and a steering system to control orientation of the vessel relative to the water and the airstream. A method of producing hydrogen comprises floating a vessel in open sea in areas of wind; rotating a wind turbine with the wind to produce electrical energy; synthesizing hydrogen gas from seawater utilizing the electrical energy from the wind turbine; storing the hydrogen gas in a storage system transported by the vessel; and offloading the hydrogen from the storage system.

### PRIORITY APPLICATION

This application claims priority to U.S. Provisional Patent Application Ser. No. 63/347,349, filed on May 31, 2022, the disclosure of which is incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document or portions incorporated herein by reference: Copyright Matthew Lackner, Amherst, MA, USA, James Manwell, Conway, MA, USA, and Aaron Annan, Harwick, MA, USA. All Rights Reserved.

### TECHNICAL FIELD

This document pertains generally, but not by way of limitation, to wind turbines. More specifically, but not by way of limitation, this document pertains to offshore wind turbines.

### BACKGROUND

Wind turbines typically include a nacelle that is supported by a tower supported on the ground. A rotor is typically mounted to the nacelle in a rotatable fashion. A plurality of rotor blades can extend from the rotor and can be shaped to be driven by air streams pushing against the rotor blades. The rotor is typically coupled to a generator by a shaft to produce electricity.

The efficiency of a wind turbine can be correlated to the speed of the air pushing against and passing over the rotor blades. Generally, windspeeds are higher offshore, such as out in the open sea on the ocean, where topographical wind obstructions are absent. Traditional fixed-foundation wind turbine technologies are typically limited to coastal areas. It is, therefore, desirable to position wind turbines at sea. However, the cost and complexity of mounting wind turbine towers to the ocean floor can be prohibitive, particularly for positioning far out at sea where wind speeds are high. Conventional fixed foundation offshore wind farms are used at water depths of about thirty meters.

Other attempts to harvest wind energy further out at sea in deeper water have utilized floating wind turbines. Floating wind turbines can benefit from the higher wind speeds on open water, but are still typically employed close to coastal cities where infrastructure is available to support the wind turbines. Floating wind typically still require moorings or anchoring systems to keep the floating wind turbines from drifting astray. Floating wind turbines therefore have high installation and maintenance costs that are not always recuperated by the higher amount of available wind energy. Accordingly, there is ongoing need to improve wind turbines and wind harvesting technology.

Examples of floating wind farms are described in Pub. No. US 2011/0074155 to Scholte-Wassink, titled “FLOATING OFFSHORE WIND FARM, A FLOATING OFFSHORE WIND TURBINE AND A METHOD FOR POSITIONING A FLOATING OFFSHORE WIND TURBINE.”

### Overview

The present inventors have recognized, among other things, that problems to be solved can include inefficiencies that can exist in conventional fixed-foundation and floating wind farms. For example, such wind farms are stationary and limited to harvesting wind at a particular location, thereby being limited to when wind conditions are favorable. Furthermore, installation and maintenance costs associated with fixed-foundation and floating wind farms at sea can be prohibitive.

The present subject matter can help provide solutions to these and other problems, such as by providing a mobile floating offshore wind energy system, herein termed a “wind trawler.” The wind trawlers of the present disclosure can comprise autonomously operated vessels that can travel out to high-wind areas at sea. The autonomously operated vessel can venture out to deeper waters than are accessible with conventional fixed-foundation and floating wind turbines. The autonomous vessels can harvest wind energy using a wind turbine. Electricity generated by the wind turbine can be used to power one or more electrolyzers that can convert seawater to hydrogen. The hydrogen can be stored for later retrieval from the vessel for use in electricity production or other applications. The autonomous vessels can be utilized alone or in fleets to operate as a wind farm. As such, wind trawlers of the present disclosure can be configured to travel at sea to access higher wind speeds far offshore as opposed to those on land or near shore, and to produce, store, and deliver hydrogen back to shore or to a hydrogen recovery vehicle. The wind trawlers can operate in a plurality of different modes, including: 1) as a passively controlled hydrogen producer whilst drifting in the direction of the prevailing ambient wind, and 2) as an actively controlled hydrogen carrier implementing a marine propulsion system to transport hydrogen cargo to designated delivery locations.

In an example, a wind turbine system comprises a floatable vessel configured to move along water in two orientations; a wind turbine mounted to the floatable vessel, the wind turbine comprising a plurality of rotor blades configured to convert an airstream to rotational shaft power, and an electrical generator configured to convert the rotational shaft power of the wind turbine to electrical power; a hydrogen production system configured to be powered by the electrical generator; a propulsion system configured to propel the floatable vessel via power from the electrical generator; and a steering system to control orientation of the floatable vessel relative to the water and the airstream.

In another example, a method of producing hydrogen comprises floating a vessel in open sea in areas of wind; rotating a wind turbine with the wind to produce electrical energy; synthesizing hydrogen gas from seawater utilizing the electrical energy from the wind turbine; storing the hydrogen gas in a storage system transported by the vessel; and offloading the hydrogen from the storage system.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

FIG. 1 is a schematic perspective view of a mobile floating offshore wind energy system comprising a vessel, a wind turbine and electrolyzer.

FIG. 2 is a schematic front view of the mobile floating offshore wind energy system of FIG. 1 illustrating the wind turbine comprising a tower, a nacelle and rotor blades.

FIG. 3 is a schematic side view of the mobile floating offshore wind energy system of FIG. 1 illustrating the vessel comprising a primary hull and first and second outrigger hulls.

FIG. 4 is a schematic top view of the mobile floating offshore wind energy system of FIG. 1 illustrating orientation of the wind turbine relative to the vessel.

FIG. 5 is a first schematic diagram showing the floating offshore wind energy system of FIGS. 1-4 operating in a hydrogen production mode.

FIG. 6 is a second schematic diagram showing the floating offshore wind energy system of FIGS. 1-4 operating in a hydrogen transport mode.

FIG. 7 is a bottom view of the vessel of FIG. 1 showing a configuration of the primary hull, the first outrigger hull and the second outrigger hull.

FIG. 8 is side view of the vessel of FIG. 7 showing a draught depth T of the primary hull.

FIG. 9 is a schematic diagram showing the components of the floating offshore wind energy system of FIGS. 1-8.

FIG. 10 is a line diagram illustrating methods of operating the floating offshore wind energy system of FIGS. 1-8.

### DETAILED DESCRIPTION

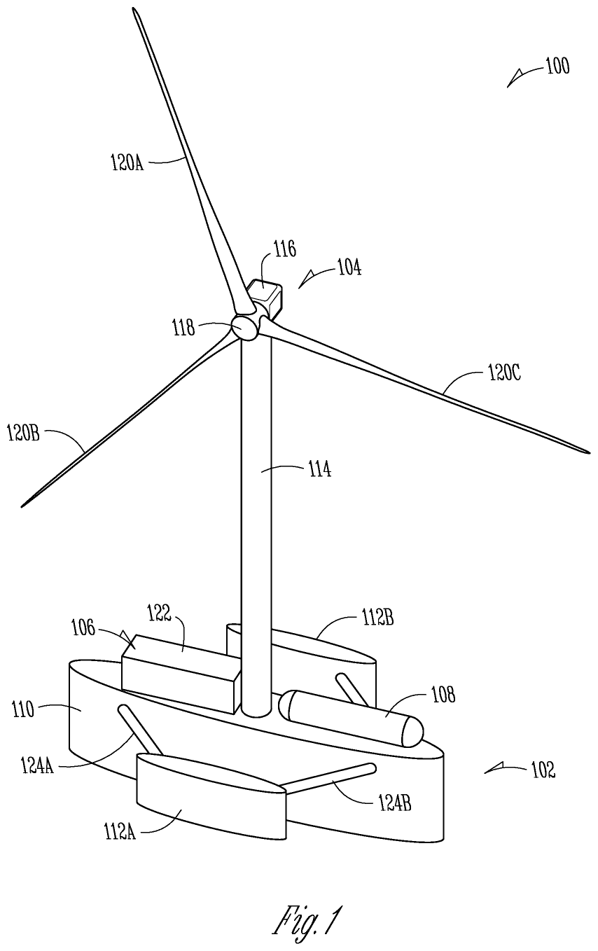

FIG. 1 is a schematic perspective view of mobile floating offshore wind energy system 100 comprising vessel 102, wind turbine 104, hydrogen production system 106 and storage system 108. Vessel 102 can comprise primary hull 110, first outrigger hull 112A and second outrigger hull 112B. Wind turbine 104 can comprise tower 114, nacelle 116, rotor 118 and turbine blades 120A, 120B and 120C. Hydrogen production system 106 can comprise electrolyzer 122.

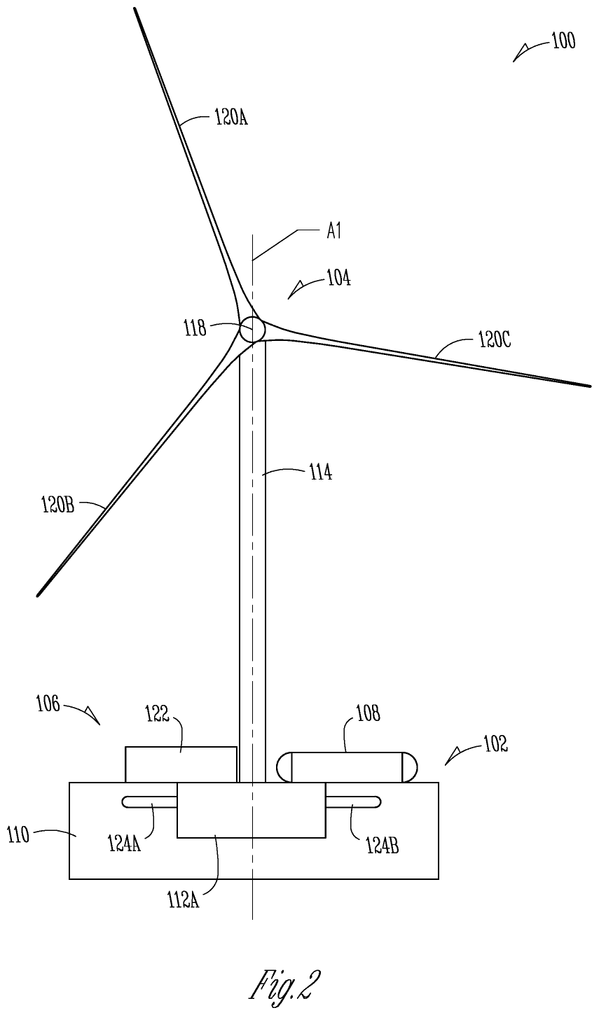

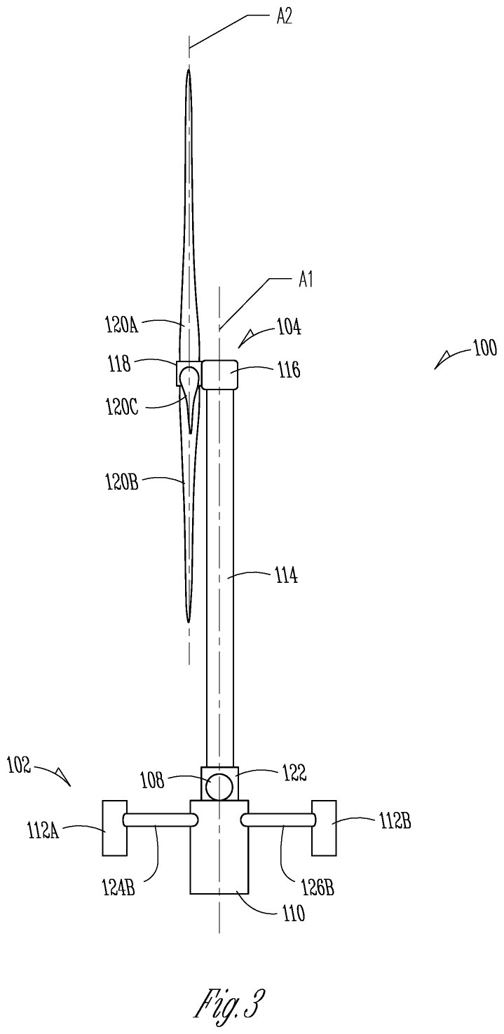

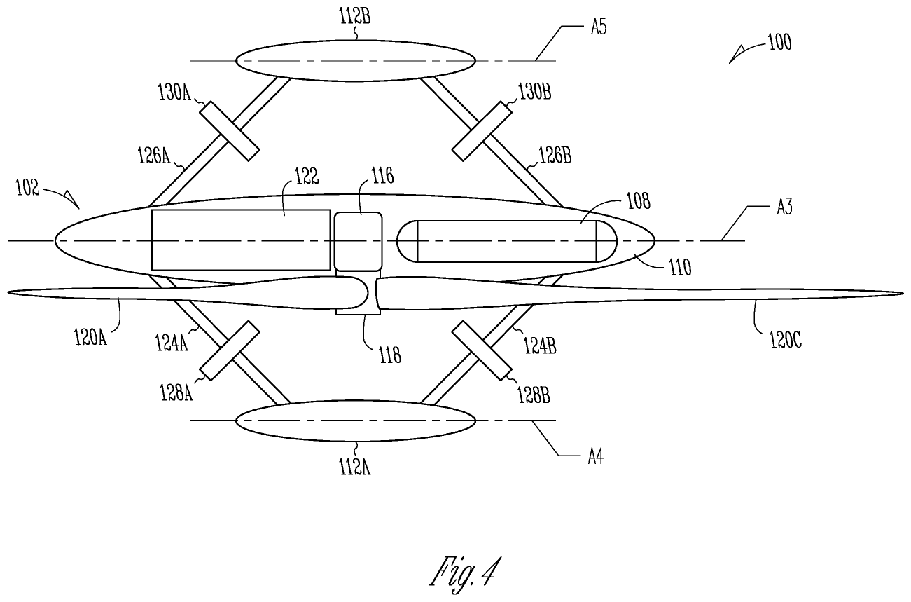

FIG. 2 is a schematic front view of mobile floating offshore wind energy system 100 of FIG. 1 illustrating wind turbine 104 comprising tower 114, nacelle 116, rotor 118 and turbine blades 120A-120C. FIG. 3 is a schematic side view of mobile floating offshore wind energy system 100 of FIG. 1 illustrating vessel 102 comprising primary hull 110, first outrigger hull 112A and second outrigger hull 112B. FIG. 4 is a schematic top view of mobile floating offshore wind energy system 100 of FIG. 1 illustrating orientation of wind turbine 104 relative to vessel 102.

First outrigger hull 112A can be connected to primary hull 110 via struts 124A and 124B. Second outrigger hull 112B can be connected to primary hull 110 via struts 126A and 126B. Rudder 128A and rudder 128B can be mounted to strut 124A and strut 124B, respectively. Rudder 130A and rudder 130B can be mounted to strut 126A and strut 126B, respectively. FIGS. 1-4 are discussed concurrently.

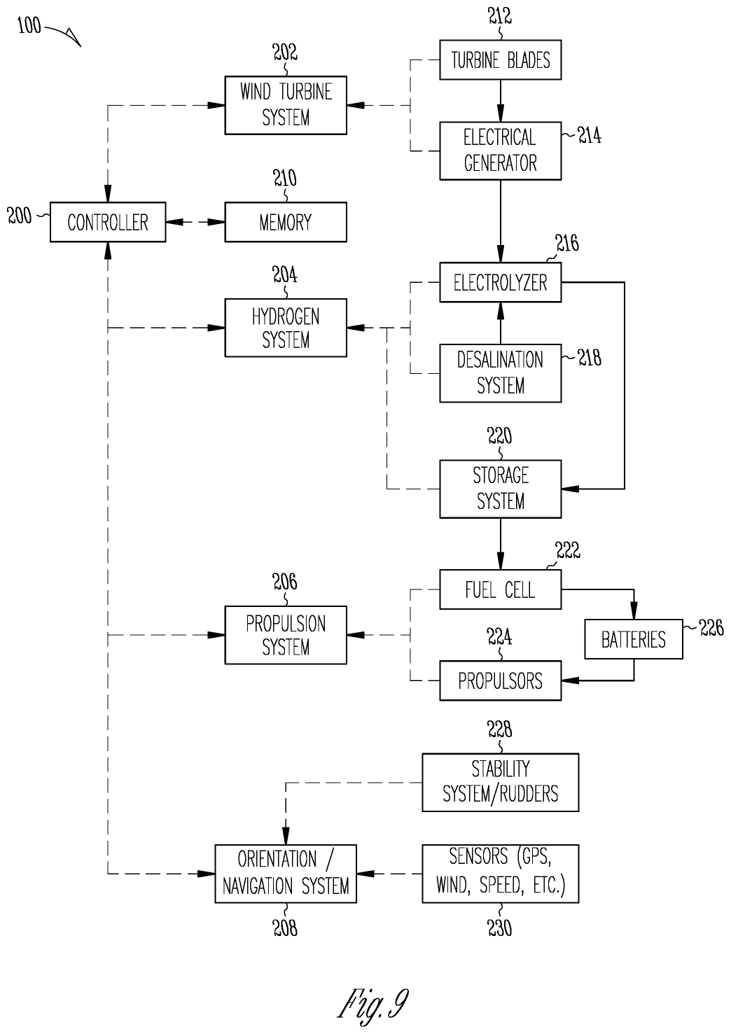

Primary hull 110 can comprise a watercraft shaped to maintain buoyancy and sail along the surface of a body of water. Primary hull 110 can be configured similarly as a boat hull having a stern, bow, gunwales and the like. Primary hull 110 can have a bottom surface having various shapes, such as flat, shallow vee, deep vee, rounded and the like. Primary hull 110 can be open on top or can be completely enclosed. Primary hull 110 can comprise a platform for mounting other components of mobile floating offshore wind energy system 100, such as hydrogen production system 106 and storage system 108. Additional components (such as those shown in FIG. 9, can be enclosed within primary hull 110. Primary hull 110 can be fabricated from any suitable material to provide a waterproof, buoyant and structurally stable platform, such as metal, wood, plastic and fiberglass.

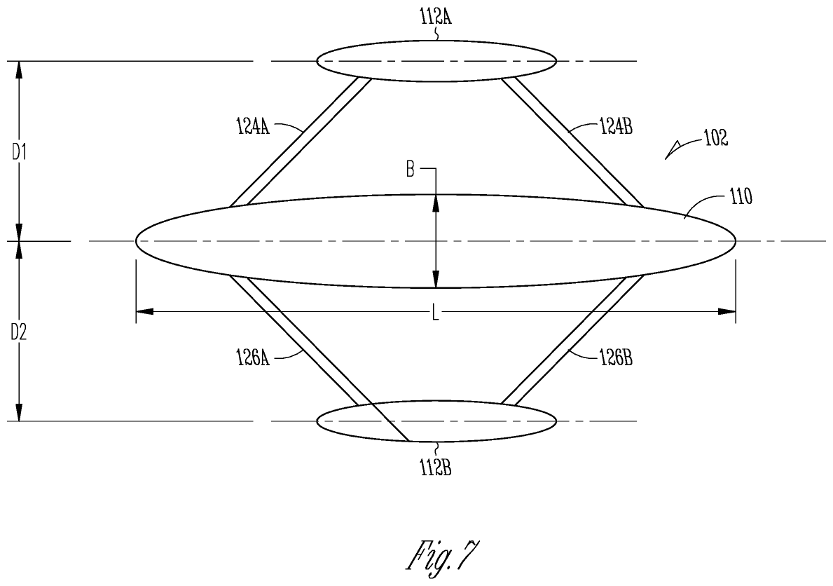

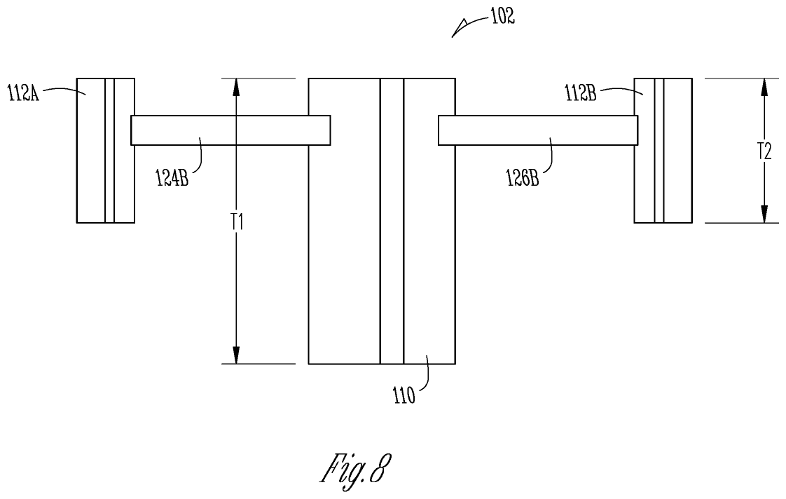

First and second outrigger hulls 112A and 112B can be configured similarly as primary hull 110, but can be smaller in scale. As discussed with reference to FIGS. 7 and 8, primary hull 110 can be longer and deeper than outrigger hulls 112A and 112B. However, in other examples, outrigger hulls 112A and 112B can be the same size or larger than primary hull 110. Struts 124A and 124B can connect outrigger hull 112A to primary hull 110. Struts 126A and 126B can connect outrigger hull 112B to primary hull 110. Struts 124A-126B can comprise rigid tubes or beams linking primary hull 110 to outrigger hulls 112A and 112B. Thus, outrigger hulls 112A and 112B can be held in a fixed relationship relative to primary hull 110. Primary hull 110 and outrigger hulls 112A and 112B can be coupled to form a floating substructure to which other components are mounted, including wind turbine 104, hydrogen production system 106 and storage system 108. In examples, primary hull 110 and outrigger hulls 112A and 112B can be connected to function as a trimaran or double-outrigger boat. In examples, vessel 102 can have a Wigley Trimaran hull form. The floating substructure can provide basic buoyancy to the component of wind turbine 104, hydrogen production system 106 and storage system 108, as well as all the other components of mobile floating offshore wind energy system 100. As discussed in greater detail below, vessel 102 can provide stability to withstand environmental conditions from waves, current, wind and the like. Vessel 102 can be configured to withstand expected environmental conditions, including various extreme weather conditions from high winds and large waves, in order to maintain the integrity of wind turbine 104 and hydrogen production system 106. Primary hull 110 can be configured to support wind turbine 104 and outrigger hulls 112A and 112B can be configured to provide additional lateral stability. For example, primary hull 110 can be configured to have buoyance to keep wind turbine 104 and other components afloat, without the added buoyancy from outrigger hulls 112A and 112B, and outrigger hulls 112A and 112B can be sized and positioned via struts 124A-126B to maintain primary hull 110 in a desired orientation, such as by preventing primary hull 110 from capsizing due to moments created at primary hull 110 due to wind turbine 104 and weather effects on wind turbine 104. In examples, second outrigger hull 112B can be larger or further away from primary hull 110 (e.g., D2 can be greater than D1 in FIG. 7) to better react wind forces acting on wind turbine 104. In examples, outrigger hulls 112A and 112B can comprise tanks for holding seawater that can be pumped in and out of outrigger hulls 112A and 112B to adjust their buoyancy and adjust the orientation of mobile floating offshore wind energy system 100, e.g., the tilt of tower 114.

Tower 114 can be mounted to primary hull 110 in any suitable fashion. In examples tower 114 can be mounted to primary hull 110 in a stationary fashion. In additional examples, tower 114 can be rotatable on axis A1 to adjust the yaw of blades 120A-120C. Tower 114 can comprise an elongate rigid body suitable for supporting nacelle 116. Nacelle 116 can comprise a housing for covering other components of wind turbine 104, such as gear systems, an electrical generator, bearings, drive shafts and the like. In examples, nacelle 116 can be mounted in a fixed position on tower 114. In additional examples, nacelle 116 can be rotatable relative to axis A1 of tower 114. An input shaft for an electrical generator can extend from nacelle 116 to couple to rotor 118. Rotor 118 can comprise a hub or rotatable body for coupling to blades 120A-120C. Rotor 118 can comprise sockets for receiving ends of blades 120A-120C. Blades 120A-120C can be fixed within rotor 118 or can be rotatable about their axes, e.g., so as to have variable pitch. In examples, the diameter of blades 120A-120C mounted to rotor 118 can be approximately two-hundred meters or more. Aerodynamic interactions between blades 120A-120C and wind can induce rotation of rotor 118, thereby rotating the input shaft to the electrical generator within nacelle 116. Wind turbine 104 can be configured as a conventional wind turbine. In examples, wind turbine 104 can comprise an IEA 15MW Reference Turbine, co-developed by the National Renewable Energy Laboratory and Technical University of Denmark having a rotor radius of 120 meters. Wind turbine 104 can provide the primary power plant of mobile floating offshore wind energy system 100.

Hydrogen production system 106 can comprise a system for synthesizing hydrogen from water. In examples, hydrogen production system 106 can comprise one or more electrolyzers that convert water (H2O) into hydrogen gas (H2) and oxygen gas (O2). The hydrogen gas can be stored in storage system 108 and the oxygen gas can be released to the atmosphere. In examples, hydrogen production system 106 can comprise eight electrolyzers each configured to use approximately two megawatts of power from wind turbine 104. In examples, hydrogen production system 106 can utilize commercially available electrolyzers, such as the 3MEP Cube available from ITM Power of Sheffield, United Kingdom. Hydrogen production system 106 can operate using electrical input from the electrical generator of wind turbine 104. Hydrogen production system 106 can further comprise a desalination system (see desalination system 218 of FIG. 9) for removing salt from seawater.

Storage system 108 can comprise any suitable device or system for storing hydrogen. In examples, storage system 108 can store liquid or gas hydrogen. In examples, storage system 108 can be configured to hold approximately three-thousand cubic meters of hydrogen gas and can comprise a cylindrical body approximately fifty meters long having a diameter of approximately ten meters. Storage system 108 can further comprise various components for transporting and pressurizing hydrogen, such as pumps, conduit and compressors.

With specific reference to FIGS. 3 and 4, wind turbine 104 can be oriented relative to vessel 102 to facilitate operation in a hydrogen production mode and a hydrogen transport mode. The orientation of vessel 102 with respect to the direction of travel differs by ninety degrees depending on which mode mobile floating offshore wind energy system 100 is operating in, an energy production mode or a transportation mode. The orientation of vessel 102 relative to wind turbine 104 can increase or maximize the relative wind speed between vessel 102 and the wind, thereby increasing or maximizing hydrogen production by minimizing forward velocity of vessel 102 during the production mode while minimizing hydrodynamic drag on vessel 102 and thus fuel consumption during the transportation mode.

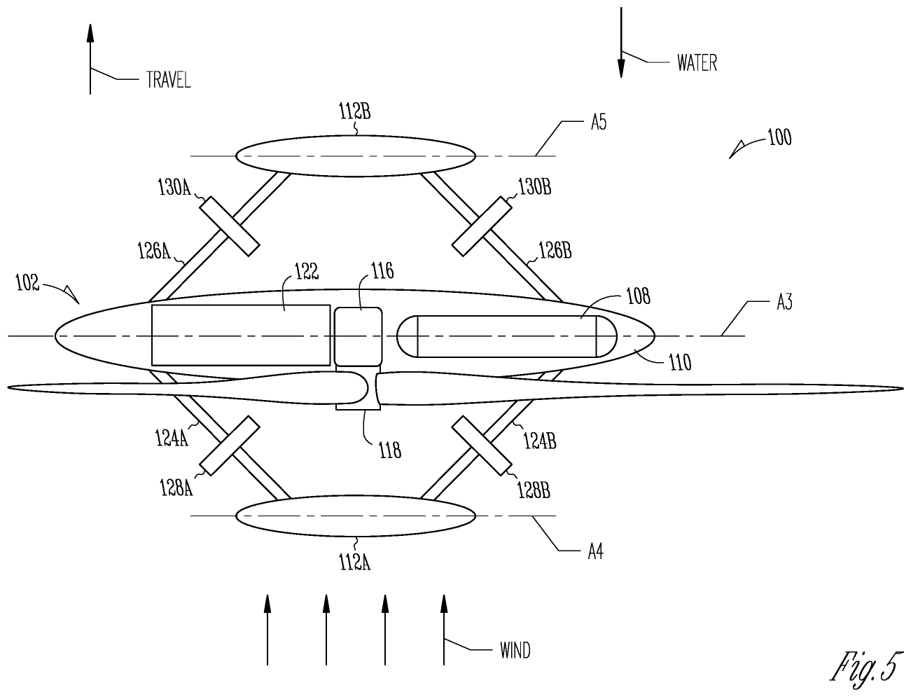

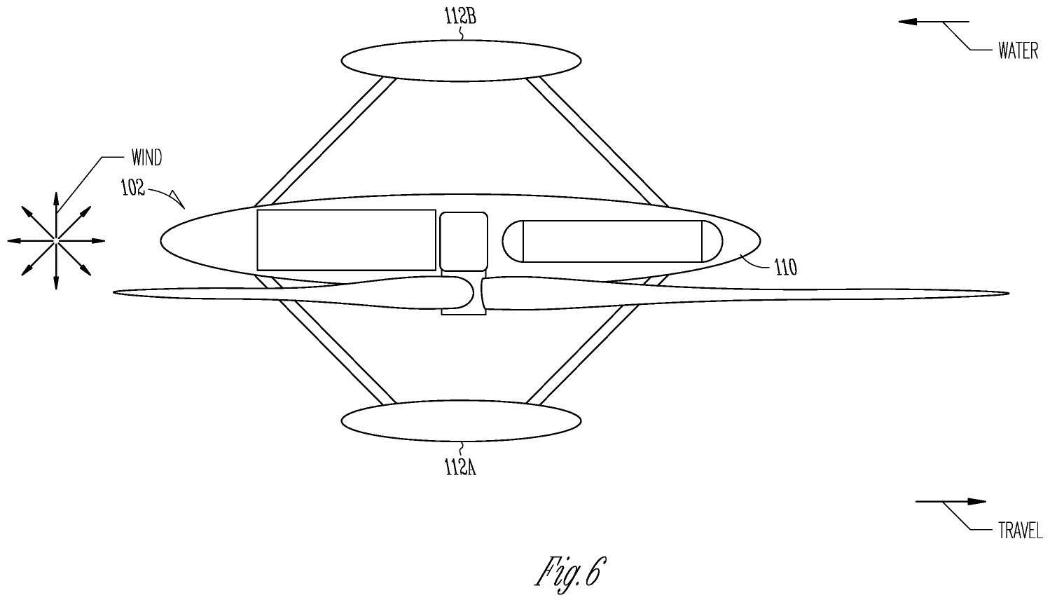

In examples, nacelle 116 can be positioned relative to tower 114 so that blades 120A-120C operate in a plane coincident with axis A2. The plane of axis A2 for blades 120A-120C can be configured to face first outrigger hull 112A. Primary hull 110 can be configured to extend along axis A3 in a direction parallel to the plane of axis A2. First outrigger hull 112A and second outrigger hull 112B can be configured to extend along axes A4 and A5, respectively, in directions parallel to axis A3. Axes A1, A3, A4 and A5 can all be fixed relative to each other. As mentioned, the location of axis A2 can be moveable depending on the rotational orientation of nacelle 116 relative to axis A1 of tower 114. However, in examples, axis A2 can be fixed in or lockable into the location of FIGS. 1-4 in order to facilitate operation in the aforementioned hydrogen production modes and hydrogen transport modes, as discussed with reference to FIGS. 5 and 6.

FIG. 5 is a first schematic diagram showing floating offshore wind energy system 100 of FIGS. 1-4 operating in a hydrogen production mode. In the energy production mode, or hydrogen production mode, vessel 102 can be oriented so that axes A2-A5 are perpendicular, or nearly perpendicular, to the direction of wind. Movement of vessel 102 due to the force of wind operating on system 100 can cause a reactionary force from water. Thus, water can be flowing opposite the direction of the wind relative to vessel 102, neglecting wave and current effects. In the illustrated example, rotor 118 is extending from nacelle 116 to face away from the direction of travel. However, in other examples, rotor 118 can be mounted to the rear of nacelle 116 to face in the direction of travel in order to facilitate balancing of vessel 102 in various configurations.

During hydrogen production, the plane of blades 120A-120C can be oriented normal to the prevailing wind direction for maximum wind energy capture. The resulting thrust on blades 120A-120C can propel system 100 in the direction of the wind, effectively reducing the relative wind speed experienced by wind turbine 104. To minimize speed in water and significant relative wind speed losses, primary hull 110 and outrigger hulls 112A and 112B can be oriented normal to the prevailing wind direction and serve as bluff bodies to the relative water motion to maximize water resistance by producing drag. Hydrogen production via hydrogen production system 106 can continue until storage tanks of storage system 108 are at capacity. Filling of storage system 108 can occur at unpredictable times and geographic locations. Thus, floating offshore wind energy system 100 can be provide with a propulsion system (see propulsion system 206 of FIG. 9) to allow floating offshore wind energy system 100 to navigate to an offloading site or to rendezvous with an offloading vehicle, such as another floating vessel or an aircraft.

In the hydrogen production mode, orientation of the plane of blades 120A-120C relative to vessel 102 can be fixed perpendicular to the axis of primary hull 110, blades 120A-120C can be allowed to rotate to produce electricity, electricity from wind turbine 104 can be provided to hydrogen production system 106, hydrogen production system 106 can be operated to convert seawater into hydrogen, and storage system 108 can be operated to retain hydrogen produced by hydrogen production system 106. Floating offshore wind energy system 100 can be left to drift where the wind and current takes it. Rudders 128A-128B can comprise mounted on a rotational axis perpendicular to the plane of movement and connected to electric motors so as to be adjustable via controller 200 (FIG. 9). Rudders 128A-130B and propulsion system 206 can be operated as needed to maintain orientation of floating offshore wind energy system 100 and to keep floating offshore wind energy system 100 on a desired course.

FIG. 6 is a second schematic diagram showing floating offshore wind energy system 100 of FIGS. 1-4 operating in a hydrogen transport mode. In the energy transport mode, or hydrogen transport mode, vessel 102 can be oriented so that axes A2-A5 are parallel, or nearly parallel, to the direction of travel. A propulsion system (see propulsion system 206 of FIG. 9) can push vessel 102 forward in the direction of travel via any suitable propulsion force, such as via thruster or propeller. Movement of vessel 102 due to the propulsive force operating on system 100 can cause a reactionary force from water. Water can be flowing opposite the direction of the wind relative to vessel 102, neglecting wave and current effects. Thus, the direction of wind relative to system 100 depends on the direction of travel, such as to a fuel delivery location.

During hydrogen transport mode, floating offshore wind energy system 100 can navigate to a predetermined delivery location using propulsion system 206. In this mode, the direction of travel of vessel 102 through the water is rotated ninety-degrees from the hydrogen production mode. In this orientation, vessel 102 can be streamlined with low drag to minimize the energy consumption from propulsion system 206 during transport. In the transport mode, wind turbine 104 can be shut down such that the forces on wind turbine 104 are those due to air drag on blades 120A-120C and tower 114. Dependent on the wind direction, air drag may reduce or increase overall resistance to the direction of travel.

In the hydrogen transportation mode, orientation of the plane of blades 120A-120C relative to vessel 102 can be fixed perpendicular to the axis of primary hull 110, blades 120A-120C can be locket to prevent rotation and minimize drag, hydrogen production system 106 can be idled or shut-down to limit electricity consumption of offshore wind energy system 100, and storage system 108 can be operated to retain hydrogen produced by hydrogen production system 106. Floating offshore wind energy system 100 can be intentionally steered along a route or to a waypoint or destination using propulsion system 206 and orientation and navigation system 208, utilizing GPS tracking and stored routes in controller 200 (FIG. 9). Rudders 128A-130B and propulsion system 206 can be operated as needed to maintain orientation of floating offshore wind energy system 100 and to keep floating offshore wind energy system 100 on a desired course.

FIG. 7 is a bottom view of vessel 102 of FIG. 1 showing a configuration of primary hull 110, first outrigger hull 112A and second outrigger hull 112B. FIG. 8 is side view of vessel 102 of FIG. 7 showing draught depth T of primary hull 110. FIGS. 7 and 8 are discussed concurrently.

The effect of orienting offshore wind energy system 100 differently depending on the mode of operation is demonstrated by the difference in water drag on the substructure between the two modes. Water drag on a submerged body is given below by Eqn. (1), relating the drag D to the shape-dependent drag coefficient C_d, density of water p w (1035 kg/m3), frontal area of the body A, and the body's velocity in water V.

$$D = \frac{1}{2} {C}_{d} {ρ}_{w} {AV}^{2} \qquad ( 1 )$$

In hydrogen production mode at low V, the bluff orientation of vessel 102 enables primary hull 110 and outrigger hulls 112A and 112B to be approximated by a flat plates, whose C_d is ˜1.3 [1]. The frontal area of hulls 110, 112A and 112B can be calculated by a rectangle formed by their length L and draught (depth of submerged portion) T1 and T2, as shown in FIG. 8.

In the transport mode, hulls 110, 112A and 112B can be streamlined and can be approximated as airfoils, whose C_d˜0.05. The frontal area now is the rectangle formed by B and T. The ratio of drag in production mode to drag in the transport mode D_P/D_T at the same velocity is given by Eqn. (2), where β=L/B is the ratio of length to beam, of which a typical value for transport hulls (of e.g. tankers and other cargo vessels) is 6.

$$\frac{{D}_{P}}{{D}_{T}} = \frac{\frac{1}{2} {C}_{d , P} {ρ}_{w} {LTV}^{2}}{\frac{1}{2} {C}_{d , T} {ρ}_{w} {BTV}^{2}} = \frac{{C}_{d , P}}{{C}_{d , T}} β \qquad ( 2 )$$

This corresponds to a drag ratio of ˜120. Offshore wind energy system 100 in the hydrogen production mode can produce one-hundred-twenty times more resistance to motion in water than in the transport mode, mitigating power loss during production and power consumption during transport.

FIG. 9 is a schematic diagram showing components of floating offshore wind energy system 100 of FIGS. 1-6. Floating offshore wind energy system 100 can comprise controller 200, wind turbine system 202, hydrogen system 204, propulsion system 206 and orientation and navigation system 208. Electrical connection is indicated with dashed lines and mechanical connection is indicated with solid lines in FIG. 9. However, other electrical and mechanical connections can be utilized.

Controller 200 can be connected to memory 210.

In examples, controller 200 can act as a peer machine in peer-to-peer (P2P) (or other distributed) network environment. Controller 200 can comprise a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Controller 200 can comprise a computer system and can include a hardware processor (e.g., a central processing unit (CPU), a graphics processing unit (GPU), a hardware processor core, or any combination thereof), main memory and static memory, some or all of which may communicate with each other via an interlink, which can comprise a bus. Controller 200 can further include a display unit, an alphanumeric input device (e.g., a keyboard), and a user interface (UI) navigation device (e.g., a mouse). In an example, the display unit, input device and UI navigation device can be a touch screen display. Controller 200 can include output controller, such as a serial (e.g., Universal Serial Bus (USB), parallel, or other wired or wireless (e.g., infrared (IR), near field communication (NFC), etc.) connection to communicate or control one or more peripheral devices (e.g., a printer, card reader, etc.).

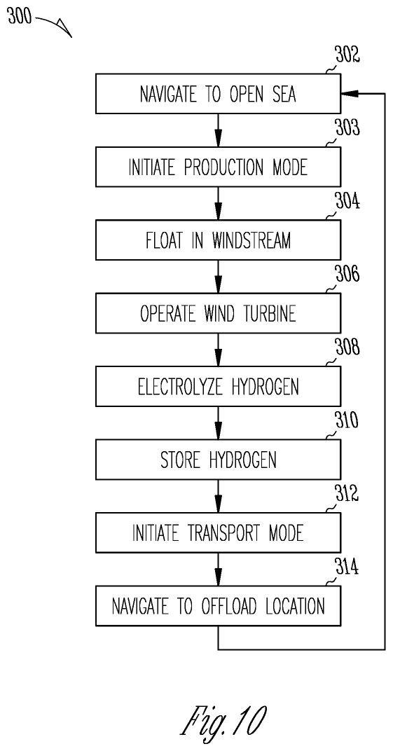

Memory 210 can comprise can include a machine-readable medium on which is stored one or more sets of data structures or instructions (e.g., software) embodying or utilized by any one or more of the techniques or functions described herein, such as for operating floating offshore wind energy system 100 and executing the control logic illustrated in FIG. 10. The instructions can also reside, completely or at least partially, within the main memory, within the static memory, or within the hardware processor during execution thereof by controller 200. In examples, one or any combination of the hardware processor, the main memory, the static memory, or the storage device can constitute machine readable media. The machine-readable medium can be a single medium. However, the term “machine-readable medium” can include a single medium or multiple media (e.g., a centralized or distributed database, and/or associated caches and servers) configured to store the one or more instructions. The term “machine-readable medium” can include any medium that is capable of storing, encoding, or carrying instructions for execution by controller 200 and that cause controller 200 to perform any one or more of the techniques of the present disclosure, or that is capable of storing, encoding or carrying data structures used by or associated with such instructions. Non-limiting machine-readable medium examples may include solid-state memories, and optical, magnetic media, random access memory, read only memory and others.

Memory 210 can comprise instructions for navigating floating offshore wind energy system 100 to locations at sea where desirable, high winds are frequently available. Memory 210 can include instructions for utilizing sensor data from sensors 230 to maintain stability and avoid collisions with objects.

Controller 200 can be configured to communicate with external systems, such as to facilitate docking and unloading of hydrogen with a port facility or a retrieval vehicle. Controller 200 can communicate via a communications network using a transmission medium via a network interface device utilizing any one of a number of transfer protocols (e.g., frame relay, internet protocol (IP), transmission control protocol (TCP), user datagram protocol (UDP), hypertext transfer protocol (HTTP), CANBus etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device can include one or more physical jacks (e.g., Ethernet, coaxial, fiber or phone jacks) or one or more antennas to connect to a communications network. In an example, the network interface device can include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by controller 200, and includes digital or analog communications signals or other intangible medium to facilitate communication of such software.

Wind turbine system 202 can comprise turbine blades 212 and electrical generator 214. Turbine blades 212 can comprise blades 120A-120C of FIGS. 1-6 and can be of conventional wind turbine design. Electrical generator can comprise any suitable device configured to convert rotational shaft input into electrical output, such as dynamos and alternators.

Hydrogen system 204 can comprise electrolyzer 216, desalination system 218 and storage system 220. In additional examples of mobile floating offshore wind energy system 100, hydrogen system 204 can be configured to produce ammonia. For example, hydrogen system 204 can include a Haber-Bosch device to convert hydrogen to ammonia using nitrogen from the atmosphere. Ammonia can be more readily stored than hydrogen.

Electrolyzer 216 can comprise hydrogen production system 106. Electrolyzer 216 can comprise conventional technology for converting water into hydrogen gas and oxygen gas via chemical reaction, such as by using an anode and a cathode separated by an electrolyte. In examples, electrolyzer 216 can comprise a polymer electrolyte membrane (PEM) electrolyzer, an alkaline (AEL) electrolyzer and a solid oxide (SOEC) electrolyzer.

Desalination system 218 can comprise a system for removing salt from water. In examples, desalination system 218 can comprise conventional technology for removing salt from water. For example, desalination system 218 can comprise a phase change processes, a pressure-driven membrane process and an electric charge-driven process. Phase change process can comprise distillation, i.e. boiling and re-condensation of seawater to leave salt and impurities behind. Pressure-driven membrane processes can comprise reverse osmosis and nano-filtration. Electric charge-driven processes can comprise electrodialysis (ED) or ion concentration polarization.

Storage system 220 can comprise storage system 108. Storage system 220 can include appropriate hoses, valving, pumps, compressors, couplers and the like to transport hydrogen from electrolyzer 216 to storage system 220 and from storage system 220 to an off-board storage system. Storage system 220 can comprise storage tanks or vessels as mentioned. Storage system 220 can be located on primary hull 110 or outrigger hulls 112A and 112B. In examples, outrigger hulls 112A and 112B can comprise storage tanks. In additional examples, storage system 220 can comprise off-board storage systems, such as floating bladders or tands or airborne balloons that can be towed by mobile floating offshore wind energy system 100.

Propulsion system 206 can comprise fuel cell 222, propulsors 224 and batteries 226.

Fuel cell 222 can comprise a system for converting hydrogen to electricity. Fuel cell 222 can comprise conventional technology for converting hydrogen to electricity. Fuel cell 222 can comprise a Polymer electrolyte membrane (PEM) fuel cell, an Alkaline (AFC) fuel cell, a Phosphoric acid (PAFC) fuel cell, a Molten carbonate (MCFC) fuel cell and a Solid oxide (SOFC) fuel cell.

Propulsors 224 can comprise any suitable water propulsion system, such as propellers, thrusters and the like. In examples, propulsors 224 can comprise electric motors that drive propellors or thrusters. The electric motors can receive electrical input from fuel cell 222. In additional examples, propulsors 224 can be driven by a combustion engine operating with hydrogen from storage system 108.

Batteries 226 can comprise conventional energy storage technology for storing electrical output of fuel cell 222. In examples, batteries 226 can comprise lithium-ion batteries. In other examples, batteries 226 can comprise lead-acid batteries, redox flow batteries, sodium-sulfur batteries and zinc-bromine flow batteries.

Orientation and navigation system 208 can comprise stability system 228 and sensors 230. Stability system 228 can comprise rudders 128A-130B, as well as other components such as keels, dagger boards, sea anchors, thrusters and the like. Sensors 230 can comprise altimeters, gyroscopic sensors, GPS sensors, wind speed sensors, water speed sensors, pressure sensors, flow sensors, temperature sensors, proximity sensors and the like.

FIG. 10 is a line diagram illustrating methods 300 of operating the floating offshore wind energy system of FIGS. 1-6.

At step 302, mobile floating offshore wind energy system 100 can be navigated out to sea, particularly to deep water areas where high winds are located. Mobile floating offshore wind energy system 100 can be launched from a land-based port at a location convenient for hydrogen processing and can be driven by an on-board propulsion to overcome wind and water resistance to reach a location suitable for wind energy harvesting. Mobile floating offshore wind energy system 100 can be provided with instructions for autonomously navigating to locations at sea where wind speeds are suitable. Mobile floating offshore wind energy system 100 can additionally be remotely controlled by an operator to travel to locations at sea where wind speeds are suitable. Mobile floating offshore wind energy system 100 can be navigated to locations where the wind and sea current can move mobile floating offshore wind energy system 100 in a predictable pattern, such as a loop.

At step 303, mobile floating offshore wind energy system 100 can be put into a hydrogen production mode.

At step 304, mobile floating offshore wind energy system 100 can float in the seawater and can be pushed by the wind and sea current. Propulsion systems for mobile floating offshore wind energy system 100 can be disengaged.

At step 306, wind turbine 104 of mobile floating offshore wind energy system 100 can be put into an operating mode where blades 120A-120C are free to rotate and produce electricity.

At step 308, hydrogen production system 106 of mobile floating offshore wind energy system 100 can be operated to produce hydrogen from seawater.

At step 310, hydrogen produced by hydrogen production system 106 can be stored in storage system 108.

At step 312, mobile floating offshore wind energy system 100 can be put in a hydrogen transport mode where mobile floating offshore wind energy system 100 is prepared for active navigation and propulsion.

At step 314, mobile floating offshore wind energy system 100 can be navigated to a location where hydrogen from storage system 108 can be offloaded. Mobile floating offshore wind energy system 100 can be driven by an on-board propulsion to overcome wind and water resistance to reach a location suitable for offloading hydrogen, such as the starting port location, a different port location, the location of a stationary hydrogen recovery platform at sea or the location of a mobile hydrogen recovery craft, such as a seafaring vessel or an aircraft.

After step 314, method 300 can return to step 302. Steps 302-314 can be repeated as desired to continuously harvest wind energy for conversion to hydrogen. Steps 302-314 can be operated as part of a “fishing boat model” where vessel 102 is navigate to a particular location to generate hydrogen and then navigated back to the same port it originated from, or another port or vessel, to offload the hydrogen. As such, floating offshore wind energy system 100 can make repeated trips to specific areas. Steps 302-314 can be operated as part of a “trade wind model” where vessel 102 is navigated along conventional trade routes to harvest wind energy. Hydrogen can be offloaded at waypoints along the route. As such, floating offshore wind energy system 100 can continuously circulate about one or more routes without a specific starting point or end point.

Further description of the construction, operation and benefits of offshore wind energy system 100, e.g., the Wind Trawler, as well as other systems, can be found in “Multi-objective Optimization for an Autonomous Unmoored Offshore Wind Energy System Substructure” by Aaron M. Annan, Matthew A. Lackner, James F. Manwell, Applied Energy, Volume 344, 2023, 121264, ISSN 0306-2619, which is hereby incorporated by this reference in its entirety for all purposes.

Mobile floating offshore wind energy system 100, e.g., the Wind Trawler, is useful for energy system in that it produces green hydrogen, or hydrogen produced from renewable energy sources and electrolysis. Considering the worldwide effort to reduce carbon emissions, green hydrogen production offers an alternative to conventional heavy carbon emitting production methods (primarily steam reformation of methane). Green hydrogen serves as an alternative energy carrier for many energy sectors looking to decarbonize, such as industrial heating and marine transportation. Considering the global offshore wind resource, the Wind Trawler is also useful in its ability to access the greatest available wind resource which is located generally farther offshore and in deeper waters. The deep offshore wind resource is considered unavailable to conventional offshore wind energy systems with substructures fixed to the seabed and requires floating system. The wind resource far from shore, for example in the North Atlantic Ocean, is the strongest of any location on earth, but is too far from shore to be accessed by conventional fixed or floating offshore wind systems.

### EXAMPLES

Example 1 is a wind turbine system comprising: a floatable vessel configured to move along water in two orientations; a wind turbine mounted to the floatable vessel, the wind turbine comprising: a plurality of rotor blades configured to convert an airstream to rotational shaft power; and an electrical generator configured to convert the rotational shaft power of the wind turbine to electrical power; a hydrogen production system configured to be powered by the electrical generator; a propulsion system configured to propel the floatable vessel via power from the electrical generator; and a steering system to control orientation of the floatable vessel relative to the water and the airstream.

In Example 2, the subject matter of Example 1 optionally includes a tower extending vertically from the floatable vessel to support the wind turbine.

In Example 3, the subject matter of Example 2 optionally includes wherein rotational orientation of the wind turbine relative to the floatable vessel is fixed.

In Example 4, the subject matter of any one or more of Examples 1-3 optionally include wherein the hydrogen production system comprises an electrolyzer.

In Example 5, the subject matter of Example 4 optionally includes wherein the hydrogen production system further comprises a desalination system.

In Example 6, the subject matter of any one or more of Examples 1-5 optionally include a storage system for storing hydrogen produced by the hydrogen production system.

In Example 7, the subject matter of any one or more of Examples 1-6 optionally include wherein the propulsion system comprises a propeller or thruster configured to push the floatable vessel in a first direction.

In Example 8, the subject matter of Example 7 optionally includes wherein the propulsion system comprises a fuel cell.

In Example 9, the subject matter of Example 8 optionally includes wherein the fuel cell is configured to operate with hydrogen produced by the hydrogen production system.

In Example 10, the subject matter of any one or more of Examples 8-9 optionally include an electric motor configured to drive the propulsion system, wherein the fuel cell provides electrical input to the propulsion system. In Example 11, the subject matter of any one or more of Examples 8-10 optionally include a battery configured to store electrical power generated by the fuel cell.

In Example 12, the subject matter of any one or more of Examples 7-11 optionally include wherein the steering system comprises a rudder system.

In Example 13, the subject matter of any one or more of Examples 1-12 optionally include wherein the floatable vessel comprises a trimaran.

In Example 14, the subject matter of Example 13 optionally includes wherein the trimaran comprises: a primary hull extending along a first major axis; a first outrigger hull extending along a second major axis spaced laterally from the primary hull; and a second outrigger hull extending along a third major axis spaced laterally from the primary hull; wherein the first major axis, the second major axis and the third major axis are parallel.

In Example 15, the subject matter of Example 14 optionally includes wherein the primary hull is axially longer and deeper than the first and second outrigger hulls.

In Example 16, the subject matter of Example 15 optionally includes a plurality of struts configured to connect the first outrigger hull and the second outrigger hull with the primary hull; and one or more rudders mounted to the plurality of struts; wherein the plurality of struts are configured to space the first and second outrigger hulls from the primary hull and are positioned so as to be spaced above a water line when the floatable vessel is placed in water.

In Example 17, the subject matter of any one or more of Examples 14-16 optionally include a controller configured to operate the propulsion system and the steering system to propel the floatable vessel in a first orientation and a second orientation; wherein the first orientation is parallel to the first, second and third major axes; and wherein the second orientation is perpendicular to the first, second and third major axes.

In Example 18, the subject matter of Example 17 optionally includes sensors configured to provide feedback to the controller regarding location and orientation of the floatable vessel.

In Example 19, the subject matter of any one or more of Examples 17-18 optionally include memory in communication with the controller and having stored therein instructions for navigating the floatable vessel along sea routes.

In Example 20, the subject matter of any one or more of Examples 14-19 optionally include a ballast system for moving seawater in and out of the first and second outrigger hulls.

Example 21 is a method of producing hydrogen, the method comprising: floating a vessel in open sea in areas of wind; rotating a wind turbine with the wind to produce electrical energy; synthesizing hydrogen gas from seawater utilizing the electrical energy from the wind turbine; storing the hydrogen gas in a storage system transported by the vessel; and offloading the hydrogen from the storage system.

In Example 22, the subject matter of Example 21 optionally includes wherein floating the vessel in open sea in areas of wind comprises allowing the wind to push the vessel through water.

In Example 23, the subject matter of Example 22 optionally includes wherein floating the vessel in open sea in areas of wind comprises rotating a major axis of the vessel perpendicular to the wind such that a plane of rotation of blades of the wind turbine are perpendicular to the wind.

In Example 24, the subject matter of Example 23 optionally includes wherein the floating vessel comprises a trimaran.

In Example 25, the subject matter of any one or more of Examples 22-24 optionally include wherein floating the vessel in open sea in areas of wind comprises guiding the vessel along a trade route.

In Example 26, the subject matter of any one or more of Examples 22-25 optionally include wherein floating the vessel in open sea in areas of wind comprises guiding the vessel from a port to a wind harvesting location and then back to the port.

In Example 27, the subject matter of any one or more of Examples 21-26 optionally include wherein rotating the wind turbine with the wind to produce electrical energy further comprises generating thrust to push the vessel.

In Example 28, the subject matter of any one or more of Examples 21-27 optionally include wherein synthesizing hydrogen gas from seawater utilizing the electrical energy from the wind turbine comprises electrolyzing seawater to produce hydrogen gas and oxygen gas from the seawater.

In Example 29, the subject matter of Example 28 optionally includes wherein synthesizing hydrogen gas from seawater utilizing the electrical energy from the wind turbine further comprises desalinating the seawater.

In Example 30, the subject matter of any one or more of Examples 28-29 optionally include wherein synthesizing hydrogen gas from seawater utilizing the electrical energy from the wind turbine further comprises converting the hydrogen gas to ammonia.

In Example 31, the subject matter of any one or more of Examples 21-30 optionally include wherein storing the hydrogen gas in a storage system transported by the vessel comprises pressurizing the hydrogen gas in a storage tank carried by the vessel.

In Example 32, the subject matter of Example 31 optionally includes wherein storing the hydrogen gas in a storage system transported by the vessel comprises storing the hydrogen gas in an off-board storage tank towed by the vessel.

In Example 33, the subject matter of any one or more of Examples 21-32 optionally include wherein offloading the hydrogen from the storage system comprises navigating the vessel to an offloading location.

In Example 34, the subject matter of Example 33 optionally includes where navigating the vessel to an offloading location comprises navigating the vessel to a hydrogen retrieval vessel at sea.

In Example 35, the subject matter of any one or more of Examples 33-34 optionally include wherein navigating the vessel to an offloading location comprise stopping operation of the wind turbine.

In Example 36, the subject matter of any one or more of Examples 33-35 optionally include wherein navigating the vessel to an offloading location comprises operating a propulsor to push the vessel along a route.

In Example 37, the subject matter of Example 36 optionally includes wherein operating a propulsor to push the vessel along a route comprises generating electricity for the propulsor with a fuel cell operating with hydrogen synthesized from the seawater.

In Example 38, the subject matter of Example 37 optionally includes storing electricity generated by the fuel cell in batteries supported by the vessel.

In Example 39, the subject matter of any one or more of Examples 21-38 optionally include pumping water in and out of the vessel for ballast to control orientation of the wind turbine.

In Example 40, the subject matter of any one or more of Examples 21-39 optionally include sensing location and orientation of the vessel to facilitate maintaining the wind turbine in an upright position and steering the vessel away from objects at sea.

### Various Notes

Each of the non-limiting examples described herein can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description.

The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A wind turbine system comprising:
a floatable vessel configured to move along water in two orientations;
a wind turbine mounted to the floatable vessel, the wind turbine comprising:
a plurality of rotor blades configured to convert an airstream to rotational shaft power; and
an electrical generator configured to convert the rotational shaft power of the wind turbine to electrical power;
a hydrogen production system configured to be powered by the electrical generator;
a propulsion system configured to propel the floatable vessel via power from the electrical generator; and
a steering system to control orientation of the floatable vessel relative to the water and the airstream.

2. The wind turbine system of claim 1, further comprising a tower extending vertically from the floatable vessel to support the wind turbine.

3. The wind turbine system of claim 2, wherein rotational orientation of the wind turbine relative to the floatable vessel is fixed.

4. The wind turbine system of claim 1, wherein the hydrogen production system comprises an electrolyzer.

5. The wind turbine system of claim 4, wherein the hydrogen production system further comprises a desalination system.

6. The wind turbine system of claim 1, further comprising a storage system for storing hydrogen produced by the hydrogen production system.

7. The wind turbine system of claim 1, wherein the propulsion system comprises a propeller or thruster configured to push the floatable vessel in a first direction.

8. The wind turbine system of claim 7, wherein the propulsion system comprises a fuel cell.

9. The wind turbine system of claim 8, wherein the fuel cell is configured to operate with hydrogen produced by the hydrogen production system.

10. The wind turbine system of claim 8, further comprising an electric motor configured to drive the propulsion system, wherein the fuel cell provides electrical input to the propulsion system.

11. The wind turbine system of claim 8, further comprising a battery configured to store electrical power generated by the fuel cell.

12. The wind turbine system of claim 7, wherein the steering system comprises a rudder system.

13. The wind turbine system of claim 1, wherein the floatable vessel comprises a trimaran.

14. The wind turbine system of claim 13, wherein the trimaran comprises:
a primary hull extending along a first major axis;
a first outrigger hull extending along a second major axis spaced laterally from the primary hull; and
a second outrigger hull extending along a third major axis spaced laterally from the primary hull;
wherein the first major axis, the second major axis and the third major axis are parallel.

15. The wind turbine system of claim 14, wherein the primary hull is axially longer and deeper than the first and second outrigger hulls.

16. The wind turbine system of claim 15, further comprising:
a plurality of struts configured to connect the first outrigger hull and the second outrigger hull with the primary hull; and
one or more rudders mounted to the plurality of struts;
wherein the plurality of struts are configured to space the first and second outrigger hulls from the primary hull and are positioned so as to be spaced above a water line when the floatable vessel is placed in water.

17. The wind turbine system of claim 14, further comprising:
a controller configured to operate the propulsion system and the steering system to propel the floatable vessel in a first orientation and a second orientation;
wherein the first orientation is parallel to the first, second and third major axes; and
wherein the second orientation is perpendicular to the first, second and third major axes.

18. The wind turbine system of claim 17, further comprising sensors configured to provide feedback to the controller regarding location and orientation of the floatable vessel.

19. The wind turbine system of claim 17, further comprising memory in communication with the controller and having stored therein instructions for navigating the floatable vessel along sea routes. The wind turbine system of claim 14, further comprising a ballast system for moving seawater in and out of the first and second outrigger hulls.

21. A method of producing hydrogen, the method comprising:
floating a vessel in open sea in areas of wind;
rotating a wind turbine with the wind to produce electrical energy;
synthesizing hydrogen gas from seawater utilizing the electrical energy from the wind turbine;
storing the hydrogen gas in a storage system transported by the vessel; and
offloading the hydrogen from the storage system.

22. The method of claim 21, wherein floating the vessel in open sea in areas of wind comprises allowing the wind to push the vessel through water.

23. The method of claim 22, wherein floating the vessel in open sea in areas of wind comprises rotating a major axis of the vessel perpendicular to the wind such that a plane of rotation of blades of the wind turbine are perpendicular to the wind.

24. The method of claim 23, wherein the floating vessel comprises a trimaran. The method of claim 22, wherein floating the vessel in open sea in areas of wind comprises guiding the vessel along a trade route.

26. The method of claim 22, wherein floating the vessel in open sea in areas of wind comprises guiding the vessel from a port to a wind harvesting location and then back to the port.

27. The method of claim 21, wherein rotating the wind turbine with the wind to produce electrical energy further comprises generating thrust to push the vessel.

28. The method of claim 21, wherein synthesizing hydrogen gas from seawater utilizing the electrical energy from the wind turbine comprises electrolyzing seawater to produce hydrogen gas and oxygen gas from the seawater.

29. The method of claim 28, wherein synthesizing hydrogen gas from seawater utilizing the electrical energy from the wind turbine further comprises desalinating the seawater.

30. The method of claim 28, wherein synthesizing hydrogen gas from seawater utilizing the electrical energy from the wind turbine further comprises converting the hydrogen gas to ammonia.

31. The method of claim 21, wherein storing the hydrogen gas in a storage system transported by the vessel comprises pressurizing the hydrogen gas in a storage tank carried by the vessel.

32. The method of claim 31, wherein storing the hydrogen gas in a storage system transported by the vessel comprises storing the hydrogen gas in an off-board storage tank towed by the vessel.

33. The method of claim 21, wherein offloading the hydrogen from the storage system comprises navigating the vessel to an offloading location.

34. The method of claim 33, where navigating the vessel to an offloading location comprises navigating the vessel to a hydrogen retrieval vessel at sea.

35. The method of claim 33, wherein navigating the vessel to an offloading location comprise stopping operation of the wind turbine.

36. The method of claim 33, wherein navigating the vessel to an offloading location comprises operating a propulsor to push the vessel along a route.

37. The method of claim 36, wherein operating a propulsor to push the vessel along a route comprises generating electricity for the propulsor with a fuel cell operating with hydrogen synthesized from the seawater.

38. The method of claim 37, further comprising storing electricity generated by the fuel cell in batteries supported by the vessel.

39. The method of claim 21, further comprising pumping water in and out of the vessel for ballast to control orientation of the wind turbine.

40. The method of claim 21, further comprising sensing location and orientation of the vessel to facilitate maintaining the wind turbine in an upright position and steering the vessel away from objects at sea.
